(19) United States
(12) Patent Application Publication
(10) Pub. No.: US 2024/0169009 A1
(43) Pub. Date: May 23, 2024

(54) SYSTEM AND METHOD FOR ESTIMATED UPDATE TIMING OF CACHED DATA

(71) Applicant: Salesforce, Inc., San Francisco, CA (US)

(72) Inventor: Drew Ellison, Thornton, CO (US)

(73) Assignee: Salesforce, Inc., San Francisco, CA (US)

(21) Appl. No.: 18/058,173

(22) Filed: Nov. 22, 2022

(51) Int. Cl. G06F 16/957; G06F 16/955; G06F 16/958

(52) U.S. Cl. CPC G06F 16/9574; G06F 16/955; G06F 16/958

(57) ABSTRACT

System and method for estimated update timing of cached data. A client-side cache manager updates the active TTL for each cached data entity based on a state value and covariance values indicating the level of certainty in the state value. The state value comprises the average time between updates to server side data. Each time a particular data entity is requested from the server, the state value is updated to reflect the current estimate and the covariance value is updated to reflect the corresponding certainty Kalman filtering techniques are used which are different from standard Kalman filtering in that the same state being estimated dictates when “measurements” can be made. Additionally, the state being estimated is not directly observable; the only thing that is observable is whether the data has changed since the last time a request was made. Consequently, additional operations may be performed to improve the estimation.

### TECHNICAL FIELD

One or more implementations relate to the field of computer systems for providing health tracking and verification services; and more specifically, to a system and method for estimated update timing of cached data.

### BACKGROUND ART

A common issue encountered by software developers is determining how to minimize the number of requests and responses generated by software entities. In the context of Web development, for example, this means minimizing the number of HTTP API requests and responses. The motivating example for this problem is that typically there are many components in a web page that have shared data stored on one or more servers. Additionally, when a user moves from one page to another on a website, data from the previous page may also be used on the new page. Without techniques to minimize the number of HTTP API requests and responses, page render times can be dramatically impacted and the server load can be unnecessarily high.

A common solution to this problem is to implement a client side cache for sharing data between web components. In this approach, a developer typically defines a Time-To-Live (TTL) value for the data cached on the client. This value has units of time (e.g. milliseconds), and represents the developer's best estimate of how often data on the server changes. After a request to the server is made, subsequent requests for the same data that are made during the TTL period will be satisfied by the local cache, rather than making another HTTP API request.

### BRIEF DESCRIPTION OF THE DRAWINGS

The following figures use like reference numbers to refer to like elements. Although the following figures depict various example implementations, alternative implementations are within the spirit and scope of the appended claims. In the drawings:

FIG. 1 illustrates one implementation of a system for estimating update timing for cached data;

FIG. 2 illustrates one implementation of a method for estimating update timing for cached data;

FIG. 3 illustrates an example of the timing associated with updates in response to data requests and server updates;

FIG. 4 illustrates another implementation in which the operations for determining when to update a data entity are performed, at least in part, on a server;

FIG. 5 illustrates another implementation of a system for estimating update timing for cached data in which clients share update metrics through a synchronization server;

FIG. 6 illustrates components for coupling a client devices to one or more services from which data entities are fetched;

FIG. 7 illustrates results produced by one implementation of the invention;

FIG. 8A is a block diagram illustrating an electronic device 800 such as a client device according to some example implementations; and

FIG. 8B is a block diagram of a deployment environment according to some example implementations.

### DETAILED DESCRIPTION

The following description includes implementations of a system and method for estimating the timing for updating different types of cached data. In some implementations, the cached data comprises web pages and associated data identified by links and other encodings in the web pages. In some implementations, a “web page” identified by a Uniform Resource Locator (URL) is encoded by an HTML document which includes the additional links and encodings (e.g., JavaScript encodings, other URLs, etc).

Some implementations estimate the timing of updates associated with various types of data cached on a client electronic device (sometimes referred to below as a “client device”). These implementations can be used, for example, by client device software and/or server software to estimate the time within which requests for the data will be serviced from the local cache, and after which a request will be transmitted to the server to update the data. This duration of time may be expressed in various ways including, but not limited to, a time-to-live (TTL) value indicating a duration of time during which the cached data should be used. Note, however, that the underlying principles of the invention are not limited to TTL values, and may include other updating timing mechanism (e.g., such as a timestamp indicating the time at which the data was updated and/or a time after which the data should be updated from the server). TTL values and any other types of timing data are generally referred to herein as the “update timing” values or “update timing data”.

Various forms of data may be cached on a client device including, but not limited to, web pages (e.g., HTML files), database records, images, text, video, and audio content, each of which may be cached in a normalized data format within one or more caches of the client device. Any type of data stored in a client device cache is referred to generally as a “data entity.”

A problem with existing approaches is that the TTL of each data entity in the cache may not be well known, or may evolve over time. A less than optimal TTL setting will cause potentially many more requests to the server than are actually needed (e.g., such as when the TTL setting is set to an artificially low number compared to the actual data on the server). Historically, the solution to this problem has been to use metrics captured from the server to run a statistical analysis and determine an optimal TTL value for the data, or to use this data to set a “max-age” header in the HTTP response.

However, in many cases, the developer of the client-side logic does not have access to this data, or the developer of the REST API does not include a max-age header. Additionally, it may not be feasible to make these requests, as a web page may use APIs which are inaccessible and therefore cannot be modified in order to provide this functionality.

To address these limitations, some implementations of a client-side cache manager performs machine learning or other compute operations to update the active TTL for each data entity in the cache based on a state value and one or more covariance values indicating the level of certainty in the state value (e.g., based on the amount of noise in the system). The state value comprises the average time between updates to server side data, an unknown variable which is estimated on each request. Each time a particular data entity is requested from the servers the state value is updated to reflect the current estimate of the average time between updates and the covariance value is updated to reflect the corresponding certainty (which will tend to increase after several iterations). Some implementations use a modified version of linear quadratic estimation (LQE) as used in Kalman filtering. However, the Kalman filtering techniques used are different from standard Kalman filtering in that the same state being estimated dictates when “measurements” can be made. Additionally, the state being estimated (the average time between updates to a data entity) is not directly observable; the only thing that is observable is whether the data has changed since the last time a request was made. Consequently, additional operations are performed in some implementations to improve the estimation.

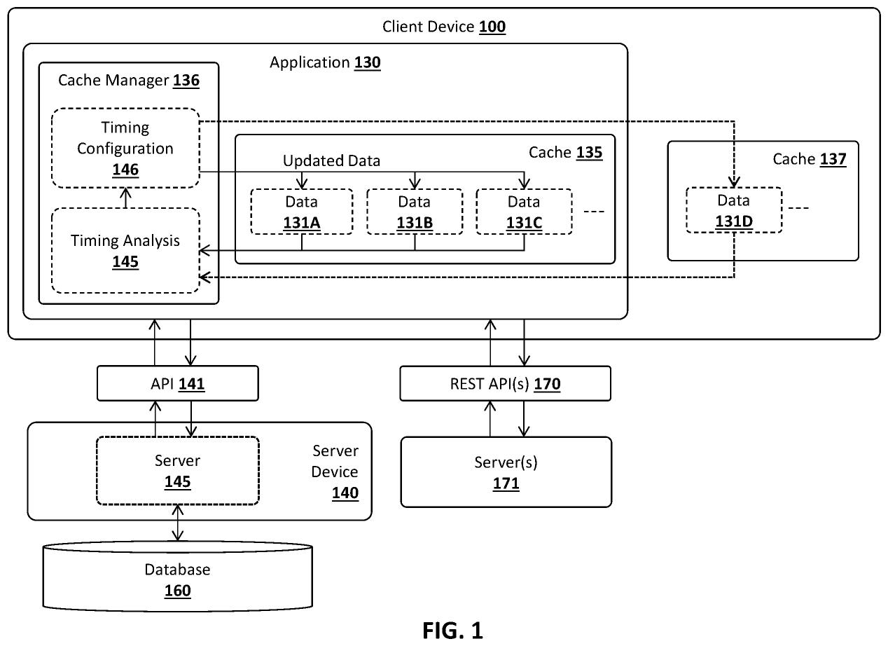

FIG. 1 illustrates one implementation of a client device 100 which addresses these limitations. A local cache 135 associated with an application 130 such as a web browser caches individual data entities 131A-C provided from one or more servers 145 in response to request messages from the application 130. In the illustrated example, the application 130 communicates with server 145 via an API 141 and may be coupled to one or more additional servers 171 via one or more REST (Representational State Transfer) APIs 170. In one implementation, each data entity 131A-C is stored in or otherwise associated with a cache entry and each cache entry is indexed with a unique URL or other type of address or index. In response to a URL selected or otherwise specified in the application 130, the client device 100 transmits a request to the server 145 for a corresponding data entity, such as a web page.

In some implementations, the application 130 may use different caches 135, 137 for caching different types of data. For example, cache 135 may be a browser cache which persistently stores web pages retrieved from a web server (e.g., server 145), where each web page is indexed in the cache 135 by its URL. Another cache 137 may be configured as an in-memory cache for storing certain data associated with the web page. For example, JavaScript code embedded in a web page may request data to populate the web page from severs 171 via one or more REST APIs 170. In this implementation, the JavaScript code maintains a local, in memory cache 137 of data associated with requests that have been made, where each cache entry is uniquely identified with an entity type or entity ID value.

In one implementation, the server 145 dynamically generates a web page based on a corresponding Hypertext Markup Language (HTML) encoding. Various forms of content stored in one or more databases 160 may be referenced in the HTML file, including images, text, data entry fields, database records, and any other type of data. The web page generated based on the HTML file may be stored as one data entity 131A within the cache 135 and the associated content referenced by the HTML file may be stored as one or more other data entities 131B-D. Upon receipt of the server response, the application 130 interprets the HTML encoding, requests any additional data identified by the embedded links to render the web page and stores a copy of the HTML encoding and associated data in the cache 135. If the web page includes JavaScript encodings, then the client device 100 executes the JavaScript code and responsively requests data to populate the web page from REST APIs 170. As mentioned, this data 131D may be stored in an in memory cache 137 and indexed by entity type or entity ID value.

Without knowledge of how frequently web pages are updated on the servers 145, 171 it is difficult to determine when cached data should be updated. In some implementations, a cache manager 136 performs the techniques described herein for individually setting the update timing for each of the data entities 131A-C in cache 135 and each of the data entities 131D in cache 137. For example, in one implementation, timing analysis logic 145 evaluates the timing of updates associated with each individual cached data entity 131A-D and timing configuration logic 146 sets the update timing associated with each data entity 131A-D. In some implementations, the update timing is a time-to-live (TTL) value, which is stored in the respective cache 135, 137 and associated with the cached data. In one implementation, for example, the TTL values are stored with the same cache entry as the data.

While a single cache manager 136 is illustrated in FIG. 1, some implementations may include separate cache managers—one for each of the different types of cache 135, 137. In this implementation, a separate instance of the timing analysis logic 145 and timing configuration logic 146 may be operated in parallel to determine and configure update timing values for data items in the different types of caches.

In some implementations, each time a data entity is retrieved from the server 145 and potentially other servers 171 via one or more REST APIs 170, the timing analysis logic 145 estimates the update timing for that data entity (e.g., in the form of a TTL value) based on whether the data entity has changed since the last request and the current update timing value, with the goal of minimizing the number of requests made to the server while at the same time capturing changes to the data from the server as fast as possible. In general, using these implementations, the update timing value will be reduced when a data entity has been updated between requests and will be increased for data which is not updated for extended periods of time (e.g., such as a static web page).

In some implementations, the timing analysis logic 145 performs machine learning to update the active TTL for each data entity 131A-D based on a state value and one or more covariance values indicating the level of certainty in the state value (e.g., based on the amount of noise in the system). In this implementation, the state value comprises the average time between updates to server side data, an unknown variable which is estimated on each request. For example, each time a particular data entity is requested from the servers 145, 171 the state value is updated to reflect the current estimate of the average time between updates and the covariance value is updated to reflect the corresponding certainty (which will tend to increase after several iterations).

Some implementations use a modified version of linear quadratic estimation (LQE) as used in Kalman filtering. Basic Kalman filtering relies on a state vector comprising a vector of real numbers and a covariance vector representing noise in the system. At each discrete time increment, a linear operator is applied to the state vector to generate the new state, with noise mixed in based on the covariance vector, and potentially information related to the controls on the system. Another linear operator mixed with additional noise generates the measurable estimate or observation from the hidden state.

The Kalman filtering techniques used in some implementations of the invention are different from standard Kalman filtering in that the same state being estimated dictates when “measurements” can be made. Additionally, in the implementations described here, the state being estimated (the average time between updates to a data entity) is not directly observable; the only thing that is observable is whether the data has changed since the last time a request was made. Consequently, additional operations are performed in some implementations to improve the estimation.

As mentioned, one implementation of the state vector contains a single value—the average time between updates to the server-side data—which is used in two distinct stages: (1) propagation of the state based on system fundamentals and (2) updates to the estimate based on measurements. Propagation is performed each time a server request is made for a given data entity, and updates are performed only if the returned data entity contains changes to the data.

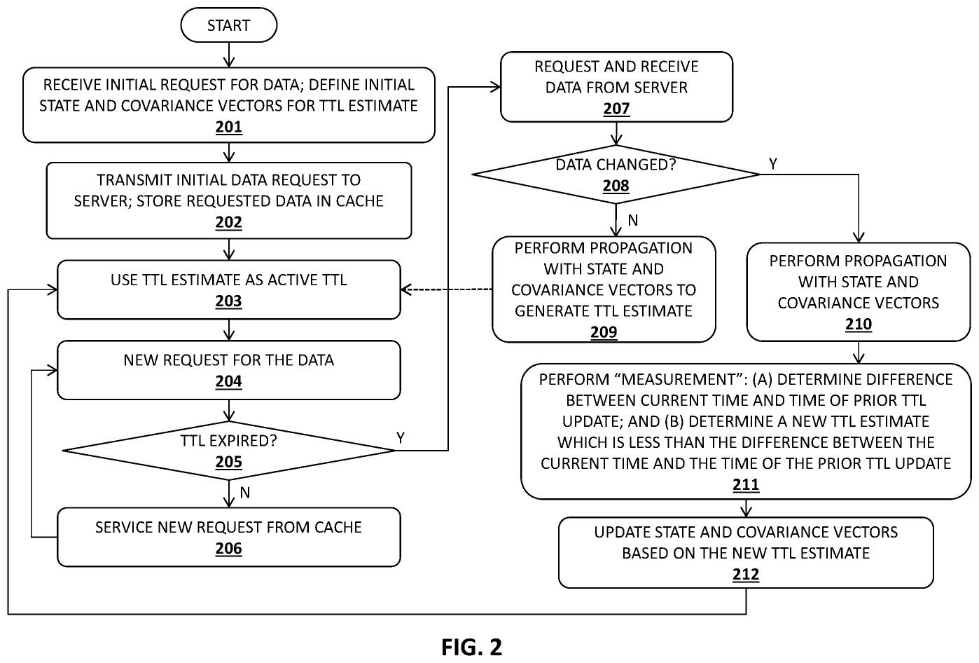

FIG. 2 illustrates a method in accordance with one implementation. The method may be implemented within the context of the various device, system, and network architectures described herein (e.g., by the timing analysis logic 145 of the cache manager 136), but is not limited to any particular architecture.

At 201, an initial request for data is received (e.g., via a browser or other application running on a client device) and the initial state and covariance vectors are defined. In one implementation, when a request for a new data entity is received, any reasonable positive number is initially selected for the state vector value (e.g. 10 seconds, 30 seconds, 3 minutes, etc) and a large covariance vector is selected, indicating high initial uncertainty (e.g. 100 s²).

At 202, the initial data request is transmitted to the server, which generates a response message including the requested data. If the server is a web server (e.g., server 145), then the data entity comprises a web page, potentially with other data entities identified via hyperlinks and/or other encodings (e.g., JavaScript). The requested data entity is stored in a cache entry. At 203, the TTL estimate is set to the active TTL associated with the cached entry.

A web page and the data entities retrieved to populate the web page may be updated at different rates on their respective servers. Thus, in some implementations, the techniques described herein for estimating TTL may be applied separately to the web page and the data entities referenced by that web page (e.g., a web page retrieved from server 145 and the corresponding data entities retrieved from one or more REST APIs 170). Moreover, as mentioned, different types of data entities may be stored in different types of caches 135, 137. While the remainder of this description will focus on the TTL for a single data entity, the same operations may be performed concurrently for multiple data entities each time a web page is requested.

At 204, a new request for the data is received at the browser or other application. If the TTL has not expired, determined at 205, then the new request is serviced from the corresponding entry in the local cache at 206. If the TTL has expired, then the data is requested and received from the server at 207.

If the data has not changed, determined at 208, then a propagation phase is performed at 209 with state and covariance vectors. In one implementation, a state transition matrix equal to identity is used for the propagation, meaning that the TTL does not have a fundamental process for evolving over time. In some implementations, if the data on the server is unchanged, the current TTL estimate is maintained. However, in other implementations, the TTL estimate is adjusted upward by a specified amount or percentage (e.g., 10%) to move the TTL value closer to the actual time at which the data is modified. In any case, the propagation time is recorded and the TTL estimate is used as the active TTL at 203.

If the data has changed, then at 210, the propagation phase is performed with the state and covariance vectors (e.g., as described above) in accordance with the detected change to the data. The “measurement” stage is then performed at 211. First, the difference between the current time and the time of the prior TTL update is determined (e.g., by subtracting the latter from the former). A new TTL estimate is then determined by reducing this value to move the TTL estimate closer to the actual data update time. For example, in one implementation, the following calculations are performed:

New TTL Estimate=(current_time−last_update_time)−((current_time−MAX([last_propagate_time,last_update_time]))*(1/n))
That is, the difference between the current time and the last TTL update time is reduced by an amount equal to the difference between the current time and the larger of the last propagation time and the last TTL update time multiplied by a fractional value (1/n) which, in one implementation, is a value between 0 and 1 (i.e., where n>1). Different values of n within this range may be selected, depending on the configuration. In one implementation, n=10, although the underlying principles of the invention are not limited to this implementation.

At 212, the state and covariance vectors are updated based on the new TTL estimate and the process returns to 203—where the TTL estimate is used as the active TTL for new requests.

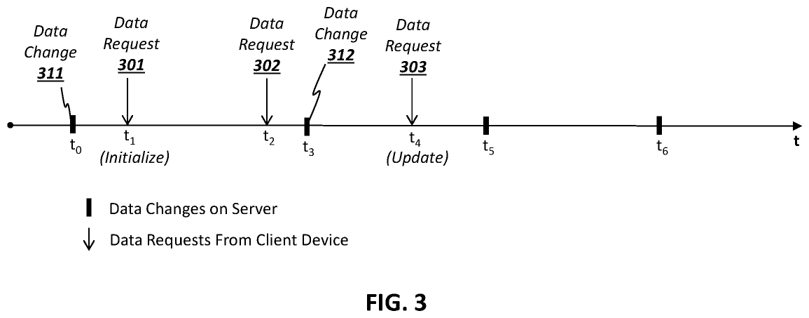

FIG. 3 illustrates the timing for one example of a sequence of data requests 301-303 and server-side data changes 311-312. The illustrated data requests 301-303 are made outside of the TTL window and sent to the server. Data requests serviced from a local cache are not shown for simplicity.

The server-side data change 311 at time to occurs prior to the initial data request 301. Because the data request 301 at time t₁ is the first request for this particular data entity, the state and covariance vectors are initialized as previously described, and the initial TTL estimate is set as the active TTL for the cached data.

When data request 302 for the same data entity is performed at time t₂, the server data is the same as when it was previously requested. The propagation phase is performed using the state and covariance vectors and the current TTL estimate may be maintained or adjusted upwards, depending on the configuration. For example, because the active TTL may be adjusted upwards by a specified amount or percentage (e.g., 10%) to move the TTL value closer to the time at which the data will be modified on the server—time t₃ in the example.

At time t₄, the client device receives another data request 303 outside of the active TTL window. A request is sent to the server and the client device detects that the data has been modified. As such, it performs both the propagation phase and measurement phase. As described above, the propagation phase is performed with the state and covariance vectors in accordance with the detected change to the data. For the measurement phase, the difference between the current time (t₄) and the time of the last TTL update (t₁) is determined and the new TTL estimate is determined by reducing this value to move the TTL estimate closer to the actual data update time. For example, the above equation may be used to reduce the difference by ((t₄−MAX([t₂, t₁]))*(1/n)), where n≥1. By way of example, and not limitation, if n=10, then this value becomes (t₄−t₂)*(0.1).

In contrast to existing implementations which require some knowledge of the server side, the implementations described herein can be performed entirely on the client device side. Thus, max-age headers and other API features are no longer needed, allowing these implementations to be used in cases where the client-side developer does not have access to the underlying API. In addition, the TTL estimation can be performed live on each client device, as opposed to statically. In contrast, existing TTL calculations are performed once, and do not support an evolving TTL.

While the implementations described above perform analysis and configuration of TTL values on the client device 100 (e.g., via the cache manager 136 of an application 130, such as a browser), some implementations perform at least a portion of this analysis and configuration on the server side, either alone or in combination with the client-side processing described above. In some implementations, a server is used to synchronize TTL values across a plurality of client devices.

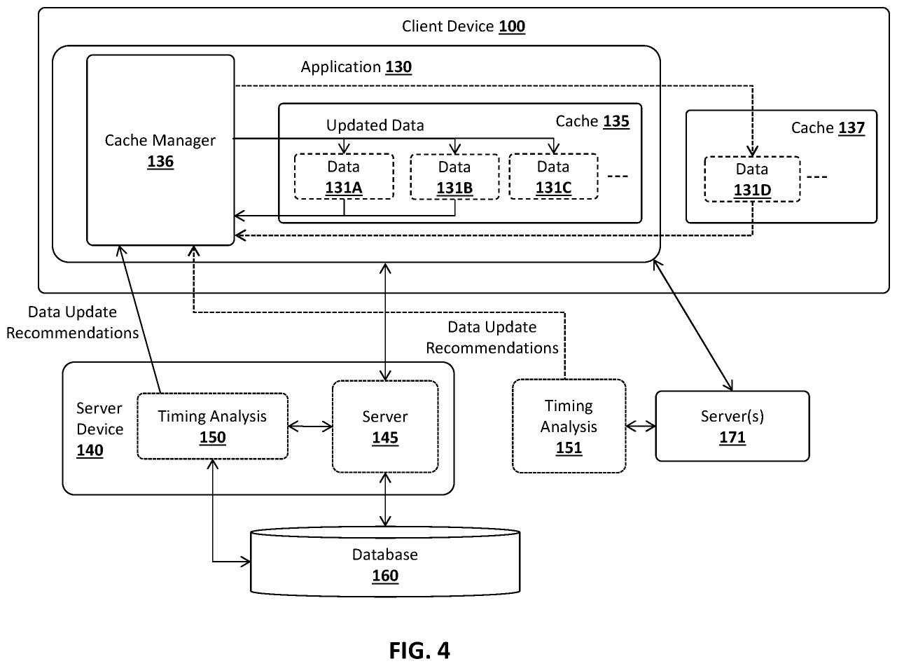

FIG. 4 illustrates one implementation in which timing analysis logic 150, 151 operated on the server device 140 and/or associated with servers 171 coupled via REST APIs performs one or more of the TTL estimation techniques described above to dynamically configure TTL values for web pages and other types of data entities. For example, the timing analysis logic 150 may set the TTL values as described above based on the detected timing of data requests received from one or more client devices 100 and the timing associated with changes to the data entities managed by the server 145. In an implementation in which the server 145 is a web server, the timing analysis 150 may track each request for a particular web page and its associated data and determine when the server response includes updated data. Similarly, timing analysis logic 151 may track requests for data at the associated servers 171.

Regardless of the type of server, when a request for data results in a response containing the same data, the timing analysis 150-151 may perform a propagation phase using the state and covariance vectors and the current TTL estimate may be maintained or adjusted upwards, depending on the configuration. When the server response includes different data, the timing analysis 150-151 performs both the propagation phase and measurement phase as described above (e.g., determining a value less than the difference between the current time and the time of the last TTL update as described above).

Once the timing analysis logic 150-151 determines a new TTL estimate, it provides the new TTL estimate to the cache manager 136 which associates it with the corresponding data in its cache 135, 137. Thus, in this implementation, at least some of the TTL estimate analysis is performed on the server device 140 rather than solely on the client device 100. Significantly, in this implementation, the timing analysis logic 150-151 may generate TTL estimates based on requests and responses for a plurality of different client devices 100, rather than a single client device, thereby improving the efficiency with which reasonable TTL estimates can be determined for different data entities (e.g., web pages and associated data). In addition, while these implementations may operate on server hardware, they do not require access to the underlying API for accessing the server. Rather, the timing analysis logic 150-151 can simply monitor requests and responses to detect when each data entity has or has not changed, and use this information to determine the TTL estimates. In this implementation, the timing analysis logic 150-151 may be implemented as a daemon or other form of background process which runs with a sufficient privilege level on the server hardware to monitor client device requests and responses.

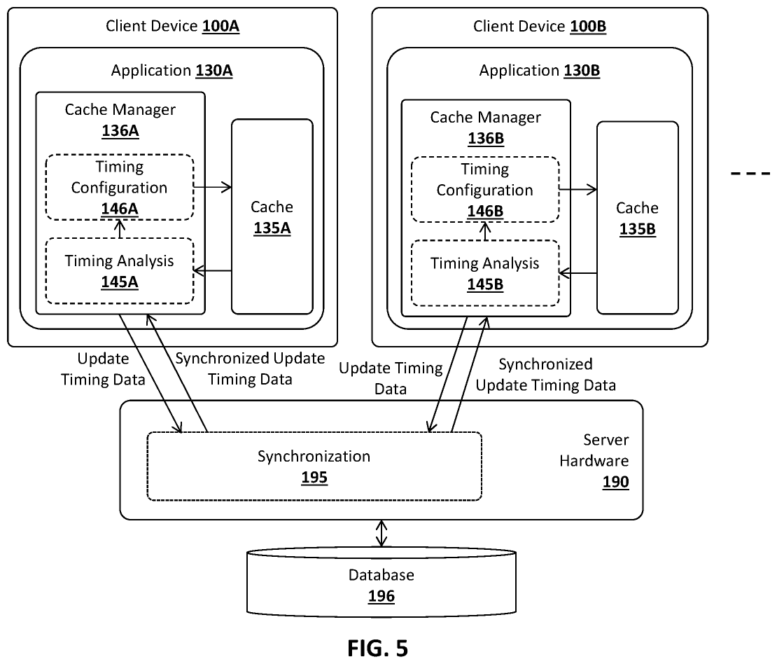

FIG. 5 illustrates another implementation in which a plurality of client devices 100A-B share TTL estimates with one another via synchronization logic 195 running on server hardware 190. As in prior implementations, each client device 100A-100B includes a cache manager 136A-B, respectively, with timing analysis logic 145A-B and timing configuration logic 146A-B, respectively, operating as described above. For example, the timing analysis logic 145A-B performs the propagation and measurement operations described above to determine new TTL values or other update timing values for each data entity stored in the local cache 135A-B of each respective application 130A-B. The timing configuration logic 146A-B then associates these timing values with each corresponding data entity within the local caches 135A-B. While only a single cache is shown for each client device for simplicity, the implementation described herein used for client devices with multiple caches and/or different types of caches such as those described above.

In this implementation, the applications 130A-B continually update the timing values for cached data entities in response to data requests and periodically transmit any new update timing values (e.g., TTL values) to the synchronization logic 195 running on the server hardware 190. In one implementation, the synchronization logic 195 merges the update timing values received from the plurality of client devices 100A-B in a database 196 or other storage device to create a compilation of update timing values received from the plurality of client devices 100A-B. The synchronization logic 195 then provides the compiled update timing values to each application 130A-B, either upon request or periodically (e.g., in accordance with a schedule).

When an application 130A-B receives a request for a data entity which is not present in its respective cache 135A-B, the corresponding cache manager 136A-B may automatically transmit a query to the synchronization logic 195 with an identifier to uniquely identify the data entity (e.g., with a URL, entity ID, or any other form of identifier). The synchronization logic 195 then uses the identifier to query the database 196 to locate the timing data (e.g., the TTL value received from a different application) associated with that data entity. If the timing data is located, then the synchronization logic 195 transmits the timing data to the requesting application 130A-B. The corresponding cache manager 136A-B then associates the update timing data with the data entity, and uses the update timing data locally to determine whether to use the cached data entity the next time a request for that data entity is received.

This implementation distributes the work of determining update timing values for different data entities among the plurality of client devices 100A-B. Once a particular application 130A has generated an update timing value for a particular data entity, it shares this update timing value with other client devices (e.g., client device 100B) via the synchronization logic 195. This implementation may be particularly beneficial for data entities which are accessed relatively infrequently from any given client device 100A-B, increasing the likelihood that timing data will be available for these data entities to efficiently control cache and server accesses for this data entity.

In some implementations, each cache manager 136A-B (or a subset thereof), periodically requests timing data updates from the synchronization logic 195 for the most recent TTL data associated with data entities in each respective cache 135A-B (e.g., so that the TTL values are current). In some cases, the cache managers 136A-B may request timing data updates even if the corresponding data entities are not cached locally. In this implementation, when a data entity is subsequently requested for the first time, the cache manager will already have the current TTL for that data entity. It will then perform the propagation and/or measurement operations described herein and provide the resulting TTL value back to the synchronization logic.

While implementations are described above in the context of web pages with embedded content, the underlying principles of the invention are not limited to these specific implementations. The techniques for managing update timing described here may be used to manage updates to any types of data entities.

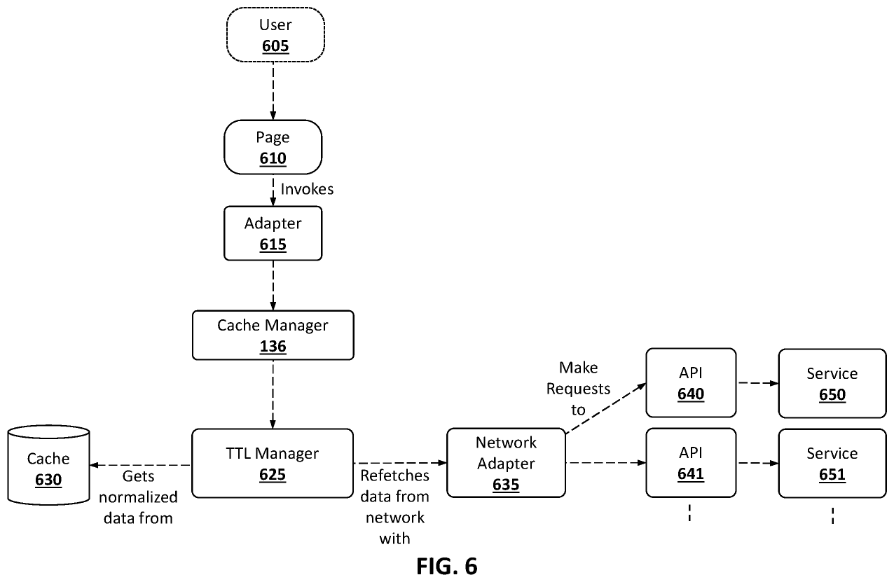

FIG. 6 illustrates relationships between different entities in accordance with some implementations. A user 605 operating a client device interacts with a page 610 rendered on within an app on the client device that uses client-side caching. In response to the user generating a request via the page 610 (e.g., by selecting a link), an adapter 615 is invoked which requests the page 610 and/or associated data entities from the cache manager 136. In this implementation, the cache manager 136 delegates construction of data entities stored in the cache to a TTL manager 625.

In one implementation, either the cache manager 136 or the TTL manager 625 perform the timing analysis and configuration techniques described herein (e.g., via propagation and/or measurement) to configure and use TTL values for different data entities within one or more local caches 630. For example, the cache manager 136 and/or TTL manager 625 may perform the functions of the timing analysis logic 145 to determine changes to TTL values and the timing configuration logic 146 to set the new TTL values for data entities in the cache 630.

In response to a data request the TTL manager 625 determines whether the request is within the TTL window for the requested data entity. If so, it retrieves the data entity from the cache 630. In some implementations, each data entity is stored within the cache 630 in a normalized format. For example, in some implementations, cache entries have a size limit and/or a fixed size. In cases where a data entity is larger than a single cache entry, it may be spread across multiple cache entries and/or compressed using one or more compression techniques (e.g., such as dictionary-based data compression). In some implementations, the cache 630 stores a pointer indicating the location of the data in a memory region.

Thus, in these implementations, the TTL manager 625 performs indexing using the URL, entity ID, or other identifier to identify the relevant cache entry (or multiple cache entries), and then denormalizes the data based before providing it to the consumer (e.g., the cache manager 136, adapter 615, etc). In some implementations, a hash value is generated based on the URL, entity ID or other identifier and used as the index to the cache. If the data was compressed, the TTL manager 625 performs decompression operations to regenerate the original data. Similarly, if the data is spread across multiple cache entries, the TTL manager 625 concatenates those cache entries (potentially following decompression if compression is used). Regardless of how the data is stored and/or denormalized, it is reconstructed by the TTL manager 625 and passed back as the page 610 through the cache manager 136 and adapter 615 and rendered for the user 603.

If the TTL manager 625 determines that the request is outside of the TTL window, then it refetches the data from one or more services 650-651 via a corresponding one or more APIs 640-641 (e.g., REST APIs as previously described). Each service 650-651 may include one or more servers accessed through a respective API 640-641. Data requests are passed to the APIs 640-641 via a network adapter 635 on the corresponding client device.

Upon receipt of the data entity from one or more services 650-651, the TTL manager 625 or cache manager 136 perform the operations previously described to adjust the TTL for the data entity. For example, if the data has not changed, then propagation may be performed to adjust the state and covariance values, with the TTL value potentially being adjusted. If the data entity has changed, then both propagation and measurement may be performed to adjust the state and covariance values, as well as the estimated TTL for the data entity. The new active TTL value is then stored and associated with the data entity in the cache 630.

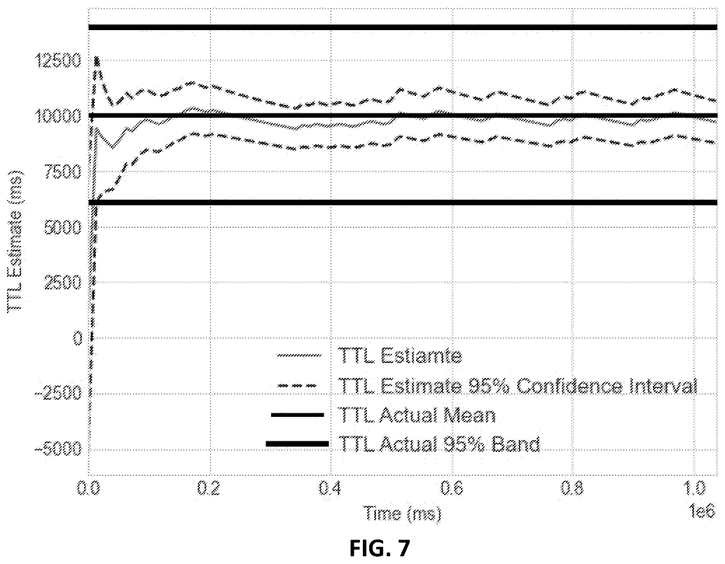

FIG. 7 illustrates a TTL estimate generated using one implementation as well as the actual average TTL average over the same time period (i.e., the average time between changes to the data entity on the server). The 95% confidence interval for the TTL estimate and the actual 95% band for the actual TTL are also illustrated. These results demonstrate that shortly after initialization, the TTL estimate closely approximates the actual average TTL. Furthermore, these results are accomplished without access to the underlying server API or prior knowledge of how frequently the data entity is updated on the server.

Example Electronic Devices and Environments

Electronic Device and Machine-Readable Media

One or more parts of the above implementations may include software. Software is a general term whose meaning can range from part of the code and/or metadata of a single computer program to the entirety of multiple programs. A computer program (also referred to as a program) comprises code and optionally data. Code (sometimes referred to as computer program code or program code) comprises software instructions (also referred to as instructions). Instructions may be executed by hardware to perform operations. Executing software includes executing code, which includes executing instructions. The execution of a program to perform a task involves executing some or all of the instructions in that program.

An electronic device (also referred to as a device, computing device, computer, etc.), includes hardware and software. Both the client device 100 and servers 145, 171 described above are forms of electronic devices. An electronic device may include a set of one or more processors coupled to one or more machine-readable storage media (e.g., non-volatile memory such as magnetic disks, optical disks, read only memory (ROM), Flash memory, phase change memory, solid state drives (SSDs)) to store code and optionally data. For instance, an electronic device may include non-volatile memory (with slower read/write times) and volatile memory (e.g., dynamic random-access memory (DRAM), static random-access memory (SRAM)). Non-volatile memory persists code/data even when the electronic device is turned off or when power is otherwise removed, and the electronic device copies that part of the code that is to be executed by the set of processors of that electronic device from the non-volatile memory into the volatile memory of that electronic device during operation because volatile memory typically has faster read/write times. As another example, an electronic device may include a non-volatile memory (e.g., phase change memory) that persists code/data when the electronic device has power removed, and that has sufficiently fast read/write times such that, rather than copying the part of the code to be executed into volatile memory, the code/data may be provided directly to the set of processors (e.g., loaded into a cache of the set of processors). In other words, this non-volatile memory operates as both long term storage and main memory, and thus the electronic device may have no or only a small amount of volatile memory for main memory.

In addition to storing code and/or data on machine-readable storage media, typical electronic devices can transmit and/or receive code and/or data over one or more machine-readable transmission media (also called a carrier) (e.g., electrical, optical, radio, acoustical or other forms of propagated signals—such as carrier waves, and/or infrared signals). For instance, typical electronic devices also include a set of one or more physical network interface(s) to establish network connections (to transmit and/or receive code and/or data using propagated signals) with other electronic devices. Thus, an electronic device may store and transmit (internally and/or with other electronic devices over a network) code and/or data with one or more machine-readable media (also referred to as computer-readable media).

Software instructions (also referred to as instructions) are capable of causing (also referred to as operable to cause and configurable to cause) a set of processors to perform operations when the instructions are executed by the set of processors. The phrase “capable of causing” (and synonyms mentioned above) includes various scenarios (or combinations thereof), such as instructions that are always executed versus instructions that may be executed. For example, instructions may be executed: 1) only in certain situations when the larger program is executed (e.g., a condition is fulfilled in the larger program; an event occurs such as a software or hardware interrupt, user input (e.g., a keystroke, a mouse-click, a voice command); a message is published, etc.); or 2) when the instructions are called by another program or part thereof (whether or not executed in the same or a different process, thread, lightweight thread, etc.). These scenarios may or may not require that a larger program, of which the instructions are a part, be currently configured to use those instructions (e.g., may or may not require that a user enables a feature, the feature or instructions be unlocked or enabled, the larger program is configured using data and the program's inherent functionality, etc.). As shown by these exemplary scenarios, “capable of causing” (and synonyms mentioned above) does not require “causing” but the mere capability to cause. While the term “instructions” may be used to refer to the instructions that when executed cause the performance of the operations described herein, the term may or may not also refer to other instructions that a program may include. Thus, instructions, code, program, and software are capable of causing operations when executed, whether the operations are always performed or sometimes performed (e.g., in the scenarios described previously). The phrase “the instructions when executed” refers to at least the instructions that when executed cause the performance of the operations described herein but may or may not refer to the execution of the other instructions.

Electronic devices are designed for and/or used for a variety of purposes, and different terms may reflect those purposes (e.g., user devices, network devices). Some user devices are designed to mainly be operated as servers (sometimes referred to as server devices), while others are designed to mainly be operated as clients (sometimes referred to as client devices, client computing devices, client computers, or end user devices; examples of which include desktops, workstations, laptops, personal digital assistants, smartphones, wearables, augmented reality (AR) devices, virtual reality (VR) devices, mixed reality (MR) devices, etc.). The software executed to operate a user device (typically a server device) as a server may be referred to as server software or server code), while the software executed to operate a user device (typically a client device) as a client may be referred to as client software or client code. A server provides one or more services (also referred to as serves) to one or more clients.

The term “user” refers to an entity (e.g., an individual person) that uses an electronic device. Software and/or services may use credentials to distinguish different accounts associated with the same and/or different users. Users can have one or more roles, such as administrator, programmer/developer, and end user roles. As an administrator, a user typically uses electronic devices to administer them for other users, and thus an administrator often works directly and/or indirectly with server devices and client devices.

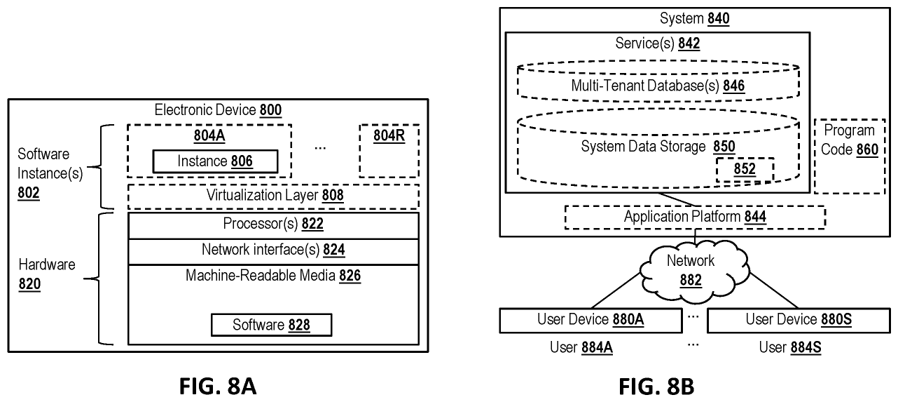

FIG. 8A is a block diagram illustrating an electronic device 800 according to some example implementations. FIG. 8A includes hardware 820 comprising a set of one or more processor(s) 822, a set of one or more network interfaces 824 (wireless and/or wired), and machine-readable media 826 having stored therein software 828 (which includes instructions executable by the set of one or more processor(s) 822). The machine-readable media 826 may include non-transitory and/or transitory machine-readable media. Each of the previously described systems, subsystems, and related components such as the application 130, cache manager 136, API 141, API 170, server 145, and server 171 may be implemented in one or more electronic devices 800. In FIG. 1, for example, the application 130 and cache manager 136 are implemented on a client device 100 and server 145 is implemented on server device 140. Although not shown for simplicity, server(s) 171, API 141, and REST API 170 are also implemented on server devices.

In one implementation: 1) each of the clients is implemented in a separate one of the electronic devices 800 (e.g., in end user devices where the software 828 represents the software such as application 130 on client device 100 interface directly and/or indirectly with servers 145, 171 (e.g., software 828 represents a web browser, a native client, a portal, a command-line interface, and/or an application programming interface (API) based upon protocols such as Simple Object Access Protocol (SOAP), Representational State Transfer (REST), etc.)); 2) the servers 145, 171 are implemented in a separate set of one or more of the electronic devices 800 (e.g., a set of one or more server devices such as server device 140 where the software 828 represents the software to implement the web server); and 3) in operation, the electronic devices implementing the clients (e.g., such as REST endpoints) and the servers 145, 171 would be communicatively coupled (e.g., by a network) and would establish between them (or through one or more other layers and/or or other services) connections over which client devices send requests and server devices responsively transmit responses (e.g., via serialized object graph requests or other mechanisms) and returning responses to the clients (e.g., serialized object graph responses or other mechanisms). Other configurations of electronic devices may be used in other implementations.

During operation, an instance of the software 828 (illustrated as instance 806 and referred to as a software instance; and in the more specific case of an application, as an application instance) is executed. In electronic devices that use compute virtualization, the set of one or more processor(s) 822 typically execute software to instantiate a virtualization layer 808 and one or more software container(s) 804A-804R (e.g., with operating system-level virtualization, the virtualization layer 808 may represent a container engine (such as Docker Engine by Docker, Inc. or rkt in Container Linux by Red Hat, Inc.) running on top of (or integrated into) an operating system, and it allows for the creation of multiple software containers 804A-804R (representing separate user space instances and also called virtualization engines, virtual private servers, or jails) that may each be used to execute a set of one or more applications; with full virtualization, the virtualization layer 808 represents a hypervisor (sometimes referred to as a virtual machine monitor (VMM)) or a hypervisor executing on top of a host operating system, and the software containers 804A-804R each represent a tightly isolated form of a software container called a virtual machine that is run by the hypervisor and may include a guest operating system; with para-virtualization, an operating system and/or application running with a virtual machine may be aware of the presence of virtualization for optimization purposes). Again, in electronic devices where compute virtualization is used, during operation, an instance of the software 828 is executed within the software container 804A on the virtualization layer 808. In electronic devices where compute virtualization is not used, the instance 806 on top of a host operating system is executed on the “bare metal” electronic device 800. The instantiation of the instance 806, as well as the virtualization layer 808 and software containers 804A-804R if implemented, are collectively referred to as software instance(s) 802.

Alternative implementations of an electronic device may have numerous variations from that described above. For example, customized hardware and/or accelerators might also be used in an electronic device.

### Example Environment

FIG. 8B is a block diagram of a deployment environment according to some example implementations. A system 840 includes hardware (e.g., a set of one or more server devices such as server device 140) and software to provide service(s) 842 (such as server 145 and server 171). In some implementations the system 840 is in one or more datacenter(s). These datacenter(s) may be: 1) first party datacenter(s), which are datacenter(s) owned and/or operated by the same entity that provides and/or operates some or all of the software that provides the service(s) 842; and/or 2) third-party datacenter(s), which are datacenter(s) owned and/or operated by one or more different entities than the entity that provides the service(s) 842 (e.g., the different entities may host some or all of the software provided and/or operated by the entity that provides the service(s) 842). For example, third-party datacenters may be owned and/or operated by entities providing public cloud services (e.g., Amazon.com, Inc. (Amazon Web Services), Google LLC (Google Cloud Platform), Microsoft Corporation (Azure)).

The system 840 is coupled to user devices 880A-880S over a network 882. The service(s) 842 may be on-demand services that are made available to one or more of the users 884A-884S working for one or more entities other than the entity which owns and/or operates the on-demand services (those users sometimes referred to as outside users) so that those entities need not be concerned with building and/or maintaining a system, but instead may make use of the service(s) 842 when needed (e.g., when needed by the users 884A-884S). The service(s) 842 may communicate with each other and/or with one or more of the user devices 880A-880S via one or more APIs (e.g., a REST API). In some implementations, the user devices 880A-880S are operated by users 884A-884S, and each may be operated as a client device and/or a server device. In some implementations, one or more of the user devices 880A-880S are separate ones of the electronic device 800 or include one or more features of the electronic device 800.

In some implementations, the system 840 is a multi-tenant system (also known as a multi-tenant architecture). The term multi-tenant system refers to a system in which various elements of hardware and/or software of the system may be shared by one or more tenants. A multi-tenant system may be operated by a first entity (sometimes referred to a multi-tenant system provider, operator, or vendor; or simply a provider, operator, or vendor) that provides one or more services to the tenants (in which case the tenants are customers of the operator and sometimes referred to as operator customers). A tenant includes a group of users who share a common access with specific privileges. The tenants may be different entities (e.g., different companies, different departments/divisions of a company, and/or other types of entities), and some or all of these entities may be vendors that sell or otherwise provide products and/or services to their customers (sometimes referred to as tenant customers). A multi-tenant system may allow each tenant to input tenant specific data for user management, tenant-specific functionality, configuration, customizations, non-functional properties, associated applications, etc. A tenant may have one or more roles relative to a system and/or service. For example, in the context of a customer relationship management (CRM) system or service, a tenant may be a vendor using the CRM system or service to manage information the tenant has regarding one or more customers of the vendor. As another example, in the context of Data as a Service (DAAS), one set of tenants may be vendors providing data and another set of tenants may be customers of different ones or all of the vendors' data. As another example, in the context of Platform as a Service (PAAS), one set of tenants may be third-party application developers providing applications/services and another set of tenants may be customers of different ones or all of the third-party application developers.

Multi-tenancy can be implemented in different ways. In some implementations, a multi-tenant architecture may include a single software instance (e.g., a single database instance) which is shared by multiple tenants; other implementations may include a single software instance (e.g., database instance) per tenant; yet other implementations may include a mixed model; e.g., a single software instance (e.g., an application instance) per tenant and another software instance (e.g., database instance) shared by multiple tenants.

In one implementation, the system 840 is a multi-tenant cloud computing architecture supporting multiple services, such as one or more of the following types of services: Marketing Cloud; Customer relationship management (CRM); Business process modeling (BPM); Customer support; External data connectivity; Productivity; Database-as-a-Service; Data-as-a-Service (DAAS or DaaS); Platform-as-a-service (PAAS or PaaS); Infrastructure-as-a-Service (IAAS or IaaS) (e.g., virtual machines, servers, and/or storage); Cache-as-a-Service (CaaS); Analytics; Community; Internet-of-Things (IoT); Industry-specific; Artificial intelligence (AI); Application marketplace (“app store”); Data modeling; Security; and Identity and access management (IAM).

For example, system 840 may include an application platform 844 that enables PAAS for creating, managing, and executing one or more applications developed by the provider of the application platform 844, users accessing the system 840 via one or more of user devices 880A-880S, or third-party application developers accessing the system 840 via one or more of user devices 880A-880S.

In some implementations, one or more of the service(s) 842 may use one or more multi-tenant databases 846, as well as system data storage 850 for system data 852 accessible to system 840. In certain implementations, the system 840 includes a set of one or more servers that are running on server electronic devices and that are configured to handle requests for any authorized user associated with any tenant (there is no server affinity for a user and/or tenant to a specific server). The user devices 880A-880S communicate with the server(s) of system 840 to request and update tenant-level data and system-level data hosted by system 840, and in response the system 840 (e.g., one or more servers in system 840) automatically may generate one or more Structured Query Language (SQL) statements (e.g., one or more SQL queries) that are designed to access the desired information from the multi-tenant database(s) 846 and/or system data storage 850.

In some implementations, the service(s) 842 are implemented using virtual applications dynamically created at run time responsive to queries from the user devices 880A-880S and in accordance with metadata, including: 1) metadata that describes constructs (e.g., forms, reports, workflows, user access privileges, business logic) that are common to multiple tenants; and/or 2) metadata that is tenant specific and describes tenant specific constructs (e.g., tables, reports, dashboards, interfaces, etc.) and is stored in a multi-tenant database. To that end, the program code 860 may be a runtime engine that materializes application data from the metadata; that is, there is a clear separation of the compiled runtime engine (also known as the system kernel), tenant data, and the metadata, which makes it possible to independently update the system kernel and tenant-specific applications and schemas, with virtually no risk of one affecting the others. In some implementations, the program code 860 may form at least a portion of the runtime, which provides the execution environment for the various services. Further, in one implementation, the application platform 844 includes an application setup mechanism that supports application developers' creation and management of applications, which may be saved as metadata by save routines. Invocations to such applications may be coded using Procedural Language/Structured Object Query Language (PL/SOQL) that provides a programming language style interface. Invocations to applications may be detected by one or more system processes, which manages retrieving application metadata for the tenant making the invocation and executing the metadata as an application in a software container (e.g., a virtual machine).

Network 882 may be any one or any combination of a LAN (local area network), WAN (wide area network), telephone network, wireless network, point-to-point network, star network, token ring network, hub network, or other appropriate configuration. The network may comply with one or more network protocols, including an Institute of Electrical and Electronics Engineers (IEEE) protocol, a 3rd Generation Partnership Project (3GPP) protocol, a 4^{th} generation wireless protocol (4G) (e.g., the Long Term Evolution (LTE) standard, LTE Advanced, LTE Advanced Pro), a fifth generation wireless protocol (5G), and/or similar wired and/or wireless protocols, and may include one or more intermediary devices for routing data between the system 840 and the user devices 880A-880S.

Each user device 880A-880S (such as a desktop personal computer, workstation, laptop, Personal Digital Assistant (PDA), smartphone, smartwatch, wearable device, augmented reality (AR) device, virtual reality (VR) device, etc.) typically includes one or more user interface devices, such as a keyboard, a mouse, a trackball, a touch pad, a touch screen, a pen or the like, video or touch free user interfaces, for interacting with a graphical user interface (GUI) provided on a display (e.g., a monitor screen, a liquid crystal display (LCD), a head-up display, a head-mounted display, etc.) in conjunction with pages, forms, applications and other information provided by system 840. For example, the user interface device can be used to access data and applications hosted by system 840, and to perform searches on stored data, and otherwise allow one or more of users 884A-884S to interact with various GUI pages that may be presented to the one or more of users 884A-884S. User devices 880A-880S might communicate with system 840 using TCP/IP (Transfer Control Protocol and Internet Protocol) and, at a higher network level, use other networking protocols to communicate, such as Hypertext Transfer Protocol (HTTP), File Transfer Protocol (FTP), Andrew File System (AFS), Wireless Application Protocol (WAP), Network File System (NFS), an application program interface (API) based upon protocols such as Simple Object Access Protocol (SOAP), Representational State Transfer (REST), etc. In an example where HTTP is used, one or more user devices 880A-880S might include an HTTP client, commonly referred to as a “browser,” for sending and receiving HTTP messages to and from server(s) of system 840, thus allowing users 884A-884S of the user devices 880A-880S to access, process and view information, pages and applications available to it from system 840 over network 882. By way of example, application 130 on client device 100 may be a browser which transmits an HTTP request to server 145 with a URL. The server 145 interprets the request to generate a particular web page, which it transmits to the application 130 on client device 100.

### CONCLUSION

In the above description, numerous specific details such as resource partitioning/sharing/duplication implementations, types and interrelationships of system components, and logic partitioning/integration choices are set forth in order to provide a more thorough understanding. The invention may be practiced without such specific details, however. In other instances, control structures, logic implementations, opcodes, means to specify operands, and full software instruction sequences have not been shown in detail since those of ordinary skill in the art, with the included descriptions, will be able to implement what is described without undue experimentation.

References in the specification to “one implementation,” “an implementation,” “an example implementation,” etc., indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, and/or characteristic is described in connection with an implementation, one skilled in the art would know to affect such feature, structure, and/or characteristic in connection with other implementations whether or not explicitly described.

For example, the figure(s) illustrating flow diagrams sometimes refer to the figure(s) illustrating block diagrams, and vice versa. Whether or not explicitly described, the alternative implementations discussed with reference to the figure(s) illustrating block diagrams also apply to the implementations discussed with reference to the figure(s) illustrating flow diagrams, and vice versa. At the same time, the scope of this description includes implementations, other than those discussed with reference to the block diagrams, for performing the flow diagrams, and vice versa.

Bracketed text and blocks with dashed borders (e.g., large dashes, small dashes, dot-dash, and dots) may be used herein to illustrate optional operations and/or structures that add additional features to some implementations. However, such notation should not be taken to mean that these are the only options or optional operations, and/or that blocks with solid borders are not optional in certain implementations.

The detailed description and claims may use the term “coupled,” along with its derivatives. “Coupled” is used to indicate that two or more elements, which may or may not be in direct physical or electrical contact with each other, co-operate or interact with each other.

While the flow diagrams in the figures show a particular order of operations performed by certain implementations, such order is exemplary and not limiting (e.g., alternative implementations may perform the operations in a different order, combine certain operations, perform certain operations in parallel, overlap performance of certain operations such that they are partially in parallel, etc.).

While the above description includes several example implementations, the invention is not limited to the implementations described and can be practiced with modification and alteration within the spirit and scope of the appended claims.

What is claimed is:

1. An article of manufacture comprising a non-transitory machine-readable storage medium that provides instructions that, if executed by an electronic device are configurable to cause the electronic device to perform operations comprising:
storing a plurality of data entities received from one or more servers in a local cache;
receiving a request for a data entity of the plurality of data entities;
determining whether to provide a version of the data entity stored in the local cache or to request a current version of the data entity from a server based on update timing data associated with the version of the data entity stored in the local cache;
requesting the current version of the data entity from the server based on the update timing data; and
if the current version of the data entity is different from the version of the data entity in the local cache, then generating a new version of the update timing data based, at least in part, on a difference between a current time and a time at which the timing data was previously updated.

2. The article of manufacture of claim 1, wherein generating the new version of the update timing data comprises:
determining the difference between the current time and the time at which the timing data was previously updated to generate a first value; and
reducing the first value by a second value.

3. The article of manufacture of claim 2 wherein the second value comprises a fractional portion of the first value or a fractional portion of a difference between the current time and a time at which a version of the data entity was previously requested from the server.

4. The article of manufacture of claim 1 wherein the update timing data comprises a time-to-live (TTL) value indicating a duration of time within which the version of the data entity in the local cache is to be provided in response to requests.

5. The article of manufacture of claim 4 wherein if the current version of the data entity is the same as the version of the data entity in the local cache, then either not updating the update timing data or increasing the TTL value by a specified amount or percentage of the current TTL value.

6. The article of manufacture of claim 1 wherein the update timing data is based on one or more state values and one or more corresponding covariance values indicating certainty associated with the one or more state values.

7. The article of manufacture of claim 6 further comprising instructions stored on the non-transitory machine-readable medium executable by the electronic device to perform the operations of:
performing propagation of the state values and one or more corresponding covariance values in response to each request for the data entity.

8. The article of manufacture of claim 7 wherein the update timing data comprises a active time-to-live (TTL) value.

9. The article of manufacture of claim 8 wherein the active TTL value is one of the one or more state values.

10. The article of manufacture of claim 1 further comprising instructions stored on the non-transitory machine-readable medium to be executed by the electronic device to cause the operations of:
transmitting the new version of the update timing data to a synchronization server;
receiving current update timing data for one or more other data entities of the plurality of data entities from the synchronization server; and
associating the current update timing data with corresponding data entities of the one or more other data entities.

11. The article of manufacture of claim 1 wherein requesting the current version of the data entity from the server further comprises transmitting a request to a Representational State Transfer (REST) application programming interface (API) associated with the server.

12. The article of manufacture of claim 1 wherein the data entity comprises a web page, a link embedded in a web page, or data identified by JavaScript code executable on a web page.

13. A method implemented in a set of one or more electronic devices, the method comprising:
storing a plurality of data entities received from one or more servers in a local cache;
receiving a request for a data entity of the plurality of data entities;
determining whether to provide a version of the data entity stored in the local cache or to request a current version of the data entity from a server based on update timing data associated with the version of the data entity stored in the local cache;
requesting the current version of the data entity from the server based on the update timing data; and
if the current version of the data entity is different from the version of the data entity in the local cache, then generating a new version of the update timing data based, at least in part, on a difference between a current time and a time at which the timing data was previously updated.

14. The method of claim 13, wherein generating the new version of the update timing data comprises:
determining the difference between the current time and the time at which the timing data was previously updated to generate a first value; and
reducing the first value by a second value.

15. The method of claim 14 wherein the second value comprises a fractional portion of the first value or a fractional portion of a difference between the current time and a time at which a version of the data entity was previously requested from the server.

16. The method of claim 13 wherein the update timing data comprises a time-to-live (TTL) value indicating a duration of time within which the version of the data entity in the local cache is to be provided in response to requests.

17. The method of claim 16 wherein if the current version of the data entity is the same as the version of the data entity in the local cache, then either not updating the update timing data or increasing the TTL value by a specified amount or percentage of the current TTL value.

18. The method of claim 13 wherein the update timing data is based on one or more state values and one or more corresponding covariance values indicating certainty associated with the one or more state values.

19. The method of claim 18 further comprising:
performing propagation of the state values and one or more corresponding covariance values in response to each request for the data entity.

20. The method of claim 19 wherein the update timing data comprises a active time-to-live (TTL) value.

21. The method of claim 20 wherein the active TTL value is one of the one or more state values.

22. The method of claim 13 further comprising:
transmitting the new version of the update timing data to a synchronization server;
receiving current update timing data for one or more other data entities of the plurality of data entities from the synchronization server; and
associating the current update timing data with corresponding data entities of the one or more other data entities.

23. The method of claim 13 wherein requesting the current version of the data entity from the server further comprises transmitting a request to a Representational State Transfer (REST) application programming interface (API) associated with the server.

24. The method of claim 13 wherein the data entity comprises a web page, a link embedded in a web page, or data identified by JavaScript code executable on a web page.
